(19) United States
(12) Patent Application Publication
(10) Pub. No.: US 2025/0105299 A1
(43) Pub. Date: Mar. 27, 2025

(54) ALL SOLID-STATE BATTERY AND ALL SOLID-STATE BATTERY STACK

(71) Applicant: SAMSUNG SDI CO,. LTD., Yongin-si (KR)

(72) Inventors: Hyuksoo SHIN, Yongin-si (KR); Jungho Lee, Yongin-si (KR); Juhee Sohn, Yongin-si (KR); Jinhoon Yang, Yongin-si (KR); Sungwon Jung, Yongin-si (KR)

(21) Appl. No.: 18/642,885

(22) Filed: Apr. 23, 2024

(30) Foreign Application Priority Data
Sep. 25, 2023 (KR) 10-2023-0128380

(51) Int. Cl. H01M 4/62; H01M 4/02; H01M 4/133; H01M 4/134; H01M 4/36; H01M 4/38; H01M 4/587; H01M 10/0562

(52) U.S. Cl. CPC H01M 4/628; H01M 4/133; H01M 4/134; H01M 4/364; H01M 4/38; H01M 4/587; H01M 10/0562; H01M 2004/021; H01M 2004/027; H01M 2300/008

(57) ABSTRACT

An all solid-state battery includes a negative electrode including a negative electrode protection layer, a negative electrode coating layer, and a negative current collector between the negative electrode protection layer and the negative electrode coating layer; a positive electrode; and a solid electrolyte layer between the negative electrode and the positive electrode.

### CROSS-REFERENCE TO RELATED APPLICATION

This application claims priority to and the benefit of Korean Patent Application No. 10-2023-0128380 filed in the Korean Intellectual Property Office on Sep. 25, 2023, the entire contents of which are incorporated herein by reference.

### BACKGROUND

### 1. Field

Embodiments relate to an all solid-state battery and an all solid-state battery stack.

### 2. DESCRIPTION OF THE RELATED ART

Recently, there has been a rapid progress in electric devices using batteries, e.g., mobile phones, laptop computers, and electric vehicles.

As such a battery, the development for an all solid-state battery using lithium metal as a negative electrode has progressed. An all solid-state battery refers to a battery in which all materials are solid, e.g., a battery using a solid electrolyte.

### SUMMARY

The embodiments may be realized by providing an all solid-state battery including a negative electrode including a negative electrode protection layer, a negative electrode coating layer, and a negative electrode current collector between the negative electrode protection layer and the negative electrode coating layer; a positive electrode; and a solid electrolyte layer between the negative electrode and the positive electrode. The negative electrode protection layer may be an insulation layer.

The negative electrode protection layer may include a fluorine adhesive, an acryl adhesive, a cyanoacrylate adhesive, a rubber adhesive, a polyurethane adhesive, a silicon adhesive, or a combination thereof.

The fluorine adhesive may include polyvinylidene fluoride, polyvinylidene fluoride-hexafluoropropylene, polytetrafluoroethylene, or a combination thereof; the acryl adhesive may include polyacrylic acid, polymethyl acrylate, polybutyl acrylate, polymethyl methacrylate, poly(ethylene-co-methyl acrylate), or a combination thereof; the cyanoacrylate adhesive may include polymethyl cyanoacrylate, polyethyl cyanoacrylate, polybutyl cyanoacrylate, polyoctyl cyanoacrylate, or a combination thereof; the rubber adhesive includes polyisoprene, a styrene-butadiene rubber, neoprene, or a combination thereof; the polyurethane adhesive may include 4,4′-, 2,4′- or 2,2′-dicyclohexylmethanediisocyanate, or a mixture thereof; 1,3- or 1,4-bis(isocyanatomethyl)cyclohexane, or a mixture thereof; 3-isocyanatomethyl-3,5,5-trimethylcyclohexylisocyanate, 2,5- or 2,6-bis(isocyanatomethyl) norbornane or a mixture thereof, or a combination thereof; and the silicon adhesive may include polymethyl siloxane, poly methyl phenyl siloxane, trimethylsilyl-terminated-polymethylsiloxane, or a combination thereof.

The negative electrode protection layer may have a thickness of about 0.1 μm to about 30 μm.

The negative electrode current collector may include copper.

The solid electrolyte layer may include a sulfide solid electrolyte.

The negative electrode coating layer may include a metal and a carbon material.

The metal may include Ag, Au, Sn, Zn, Al, Mg, Ge, Cu, In, Ni, Bi, Pt, Pd, or a combination thereof.

The carbon material may include crystalline carbon, amorphous carbon, or a combination thereof.

The embodiments may be realized by providing an all solid-state battery stack including a first unit battery including a first negative electrode, a first positive electrode, and a first solid electrolyte layer; a second unit battery including a second negative electrode, a second positive electrode, and a second solid electrolyte layer; and an elastic layer between the first unit battery and the second unit battery, wherein the first negative electrode includes a first negative electrode coating layer, a first negative electrode current collector, and a first negative electrode protecting layer, the second negative electrode includes a second negative electrode coating layer, a second negative electrode current collector, and a second negative electrode protecting layer, and the elastic layer is between the first negative electrode protecting layer and the second negative electrode protecting layer.

The first negative electrode protection layer and the second negative electrode protection layer may each be an insulation layer.

The first negative electrode protection layer and the second negative electrode protection layer may each independently include a fluorine adhesive, an acryl adhesive, a cyanoacrylate adhesive, a rubber adhesive, a polyurethane adhesive, a silicon adhesive, or a combination thereof.

The fluorine adhesive may include polyvinylidene fluoride, polyvinylidene fluoride-hexafluoropropylene, polytetrafluoroethylene, or a combination thereof; the acryl adhesive may include polyacrylic acid, polymethyl acrylate, polybutyl acrylate, polymethyl methacrylate, poly(ethylene-co-methyl acrylate), or a combination thereof; the cyanoacrylate adhesive may include polymethyl cyanoacrylate, polyethyl cyanoacrylate, polybutyl cyanoacrylate, polyoctyl cyanoacrylate, or a combination thereof; the rubber adhesive may include polyisoprene, a styrene-butadiene rubber, neoprene, or a combination thereof; the polyurethane adhesive may include 4,4′-, 2,4′- or 2,2′-dicyclohexylmethanediisocyanate, or a mixture thereof; 1,3- or 1,4-bis(isocyanatomethyl)cyclohexane, or a mixture thereof; 3-isocyanatomethyl-3,5,5-trimethylcyclohexylisocyanate, 2,5- or 2,6-bis(isocyanatomethyl) norbornane or a mixture thereof, or a combination thereof; and the silicon adhesive may include polymethyl siloxane, poly methyl phenyl siloxane, trimethylsilyl-terminated-polymethylsiloxane, or a combination thereof.

The first negative electrode protection layer and the second negative electrode protection layer may each independently have a thickness of about 0.1 μm to about 30 μm.

The first negative electrode current collector and the second negative electrode current collector may each include copper.

The first solid electrolyte layer and the second solid electrolyte layer may each independently include a sulfide solid electrolyte.

The first negative electrode coating layer and the second negative electrode coating layer may each independently include a metal and a carbon material.

The metal may include Ag, Au, Sn, Zn, Al, Mg, Ge, Cu, In, Ni, Bi, Pt, Pd, or a combination thereof.

The carbon material may include crystalline carbon, amorphous carbon, or a combination thereof.

### BRIEF DESCRIPTION OF THE DRAWINGS

Features will be apparent to those of skill in the art by describing in detail exemplary embodiments with reference to the attached drawings in which:

FIG. 1 is a schematic diagram showing the negative electrode for the all solid-state battery according to one or more embodiments.

FIG. 2 is a schematic diagram showing the all solid-state battery according to one or more embodiments.

FIG. 3 is a schematic diagram showing the all solid-state battery stack according to one or more embodiments.

FIG. 4 is an image of the current collector after charging and discharging the all solid-state battery according to Examples 1 to 3, and Comparative Examples 1 and 2.

FIG. 5 is a graph showing the cyclic voltammetry result for the negative electrode of the all solid-state battery of Example 1.

FIG. 6 is a graph showing the cyclic voltammetry result for the negative electrode of the all solid-state battery of Example 2.

FIG. 7 is a graph showing the cyclic voltammetry result for the negative electrode of the all solid-state battery of Example 3.

FIG. 8 is a graph showing the cyclic voltammetry result for the negative electrode of the all solid-state battery of Example 4.

FIG. 9 is a graph showing the cyclic voltammetry result for the negative electrode of the all solid-state battery of Example 5.

FIG. 10 is a graph showing the cyclic voltammetry result for the negative electrode of the all solid-state battery of Example 6.

FIG. 11 is a graph showing the cyclic voltammetry result for the negative electrode of the all solid-state battery of Comparative Example 1.

FIG. 12 is a graph showing the cyclic voltammetry result for the negative electrode of the all solid-state battery of Comparative Example 2.

FIG. 13 is a graph showing the cyclic voltammetry result for the negative electrode of the all solid-state battery of Comparative Example 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration.

Expressions in the singular include expressions in plural unless the context clearly dictates otherwise.

The term “combination thereof” may include a mixture, a laminate, a complex, a copolymer, an alloy, a blend, a reactant of constituents.

The terms “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

In the specification, unless explicitly described to the contrary, the word “comprise” and variations such as “comprises” or “comprising” will be understood to imply the inclusion of stated elements but not the exclusion of any other element.

The terms “about” and “substantially” used throughout the present specification refer to the meaning of the mentioned with inherent preparation and material permissible errors when presented, and are used in the sense of being close to or near that value. They are used to help understanding and to prevent unconscientious infringers from unfairly exploiting the disclosure where accurate or absolute values are mentioned.

In the specification, A and/or B or A or B is not an exclusive term, and indicates A or B or both of them.

Unless otherwise defined in the specification, it will be understood that when an element, such as a layer, a film, a region, a plate, and the like is referred to as being “on” or “over” another element, it may be directly on, connected to, or coupled to the other element or layer, or one or more intervening elements may be present. In addition, it will also be understood that when an element is referred to as being “between” two elements, it may be the only element between the two elements, or one or more intervening elements may also be present.

Herein, “particle size” or “a particle diameter”, may be an average particle diameter. Unless otherwise defined in the specification, the average particle diameter may be defined as an average particle diameter D50 indicating the diameter of particles having a cumulative volume of 50 volume % in the particle size distribution. The particle size may be measured by a method well known to those skilled in the art, for example, by a particle size analyzer, or by a transmission electron microscopic image, a scanning electron microscopic image), or a field emission scanning electron microscopy (FE-SEM). In another embodiments, a dynamic light-scattering measurement device is used to perform a data analysis, and the number of particles is counted for each particle size range, and from this, the average particle diameter (D50) value may be easily obtained through a calculation, or a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of 60 W, and calculating an average particle diameter (D50) in the 50% standard of particle distribution in the measuring device.

The term “thickness” may be measured through a photograph taken with an optical microscope such as a scanning electron microscope.

An all solid-state battery according to one or more embodiments may include a negative electrode including a negative electrode protection layer, a negative electrode coating layer, and a negative current collector between the negative electrode protecting layer and the negative electrode coating layer; a positive electrode, and a solid electrolyte layer between the negative electrode and the positive electrode.

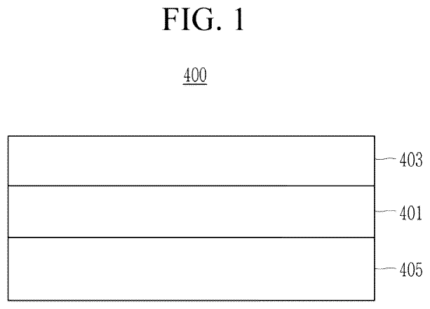

FIG. 1 schematically shows the negative electrode structure in the all solid-state battery according to one or more embodiments. The negative electrode 400 according to one or more embodiments may include, e.g., the negative electrode protection layer 405, the negative electrode current collector 401, and the negative electrode coating layer 403. As such, the negative electrode according to one or more embodiments may be formed by sequentially forming or stacking the negative electrode protection layer, the negative current collector, and the negative electrode coating layer.

The negative electrode protection layer may be on one side of the negative current collector, e.g., on the side of the negative current collector facing away from the side where the negative active material layer or the negative electrode coating layer is prepared or included, (hereinafter, referred to as “bottom”) and may help prevent the negative current collector from being exposed to the outside. This may facilitate suppression of the contact of the negative current collector with the electrolyte during charging and discharging of the all solid-state battery, thereby preventing the occurrence of the side reaction between the negative current collector and the electrolyte.

The negative electrode protection layer according to one or more embodiments may be, e.g., an insulation layer and may have an electrical conductivity of substantially 0 (zero). In an implementation, the negative electrode protection layer may be the insulation layer, and during charging and discharging of the all solid-state battery, this negative electrode protection layer may not participate in electrochemical reaction and may only effectively serve to physically prevent the negative current collector from being exposed to the outside, e.g., preventing exposure of or to the area at which the electrolyte is reacted. If the negative electrode protection layer were to be a conductive layer with electrical conductivity, the negative electrode protection layer could also participate in electrochemical reactions, which could cause corrosion of the negative current collector.

In an implementation, the negative electrode protection layer may be an insulation or insulating layer, and thus the disposition of the negative electrode protection layer between the negative current collector and the negative active material layer could cause a failure in operating the battery.

The negative electrode protection layer according to one or more embodiments may include a fluorine adhesive, an acryl adhesive, a cyanoacrylate adhesive, a rubber adhesive, a polyurethane adhesive, a silicon adhesive, or a combination thereof.

The fluorine adhesive may include, e.g., polyvinylidene fluoride, polyvinylidene fluoride-hexafluoropropylene, polytetrafluoroethylene, or a combination thereof. The acryl adhesive may include, e.g., polyacrylic acid, polymethyl acrylate, polybutyl acrylate, polymethyl methacrylate, poly(ethylene-co-methyl acrylate, or a combination thereof. The cyanoacrylate adhesive may include, e.g., polymethyl cyanoacrylate, polyethyl cyanoacrylate, polybutyl cyanoacrylate, poyl octyl cyanoacrylate, or a combination thereof. The rubber adhesive may include, e.g., polyisoprene, a styrene-butadiene rubber, neoprene, or a combination thereof. The polyurethane adhesive may include, e.g., 4,4′-, 2,4′- or 2,2′-dicyclohexylmethanediisocyanate, or a mixture thereof; 1,3- or 1,4-bis(isocyanatomethyl)cyclohexane, or a mixture thereof; 3-isocyanatomethyl-3,5,5-trimethylcyclohexylisocyanate, 2,5- or 2,6-bis(isocyanatomethyl) norbornane, or a mixture thereof, or a combination thereof, the silicon-based adhesive may be polydimethyl siloxane), poly methyl phenyl siloxane, trimethylsilyl-terminated polymethylsiloxane (PDMS), or a combination thereof.

In an implementation, a thickness of the negative electrode protection layer may be, e.g., about 0.1 μm to about 30 μm, about 0.2 μm to about 20 μm, about 0.2 μm to about 10 μm, about 0.5 μm to about 8 μm, or about 1 μm to about 5 μm. Maintaining the thickness of the negative electrode protection layer within the ranges may help ensure that the side reaction between the negative current collector and the electrolyte may be further effectively suppressed during charging and discharging, without reducing energy density.

In an implementation, the negative current collector may include, e.g., copper (Cu). The copper current collector may be economical and may be relatively thin (e.g., a thickness of about 5 μm to about 10 μm), thereby improving energy density of the all solid-state battery.

The copper current collector could cause a side reaction with the electrolyte. In an implementation, the negative electrode may include the negative electrode protection layer capable of preventing the side reaction between the current collector and the electrolyte on the bottom, so that only the advantages of the copper current collector may be effectively realized without shortcomings related to the side reaction.

In an implementation, the negative electrode coating layer refers to a layer that helps the movement of lithium ions released from the positive active material to the negative electrode during charging and discharging of the all solid-state battery, thereby facilitating their deposition on the surface of the current collector. In an implementation, a lithium deposition layer, due to the deposition of lithium ions between the current collector and the negative electrode coating layer may be formed, and the lithium deposition layer may act as a negative active material. This negative electrode may generally refer to a deposition-type negative electrode. The metal and amorphous carbon included in the negative electrode coating layer may not act as a negative active material which directly participates in the charge and discharge reaction. Such a deposition-type negative electrode may represent a negative electrode that does not include a negative active material during the battery preparation, and the lithium-included layer acts as a negative active material.

The negative electrode coating layer may include a metal, a carbon material, or combination thereof, which may serve as a catalyst.

In the negative electrode coating layer, e.g., a metal may be supported on a carbon material, or a metal and a carbon material may be mixed together.

The carbon material may include, e.g., crystalline carbon, amorphous carbon, or a combination thereof. In an implementation, the carbon material may include, e.g., amorphous carbon. The crystalline carbon may include, e.g., natural graphite, artificial graphite, mesophase carbon microbead, carbon nanotube, graphene, or a combination thereof. The crystalline carbon may have unspecified shape, sheet shape, flake shape, spherical shape, or fiber shape. The amorphous carbon may include, e.g., carbon black, acetylene black, denka black, ketjen black, furnace black, activated carbon, graphene, or combinations thereof. The carbon black may be Super P (available from Timcal, Ltd.). The amorphous carbon may include a suitable material that may be classified as amorphous carbon in the field.

In an implementation, the carbon material may be in the form of single particles or an agglomerated product that has a secondary particle form where primary particles are agglomerated. In an implementation, the carbon material may be in the form of single particles, and the carbon material may have an average particle diameter of about 100 nm or less, e.g., a nanosize of about 10 nm to about 100 nm.

In an implementation, the carbon material may be an agglomerated product, the particle diameter of the primary particle may be about 20 nm to about 100 nm, and the particle diameter of the secondary particle may be about 1 μm to about 20 μm.

In an implementation, a particle diameter of the primary particles may be about 20 nm or more, about 30 nm or more, about 40 nm or more, about 50 nm or more, about 60 nm or more, about 70 nm or more, about 80 nm or more, or about 90 nm or more and about 100 nm or less, about 90 nm or less, about 80 nm nm or less, about 70 nm or less, about 60 nm or less, about 50 nm or less, about 40 nm or less, or about 30 nm or less.

In an implementation, a particle diameter of the secondary particle may be about 1 μm or more, about 3 μm or more, about 5 μm or more, about 7 μm or more, about 10 μm or more, or about 15 μm or more, and about 20 μm or less, about 15 μm or less, about 10 μm or less, about 7 μm or less, about 5 μm or less, or about 3 μm or less.

The shape of the primary particle may be spherical, oval, plate-shaped, or combinations thereof, e.g., the shape of the primary particle may be spherical, oval, or combinations thereof.

The metal may be, e.g., Ag, Au, Sn, Zn, Al, Mg, Ge, Cu, In, Ni, Bi, Pt, Pd, or a combination thereof. The inclusion of the metal in the negative electrode coating layer may help further improve the electrical conductivity of the negative electrode.

The metal may be in the form of nano particles and the size of the metal nano particles may be, e.g., about 5 nm to about 80 nm, and it may be appropriately used. In an implementation, the metal nanoparticles with nano size may be used, and the battery characteristics, e.g., cycle-life characteristics of the all solid-state battery, may be improved. If the metal particle size were to increase to be in micrometers, the uniformity of the metal particles in the negative electrode coating layer could decrease, the current density in a specific area could increase, and cycle life characteristics could deteriorate, which is not appropriate.

In an implementation, an amount of the metal may be, e.g., about 3 wt % to about 30 wt %, about 4 wt % to about 25 wt %, about 5 wt % to about 20 wt %, or about 5 wt % to about 15 wt %, based on a total weight of the negative electrode coating layer.

In an implementation, an amount of the carbon material may be, e.g., about 70 wt % to about 97 wt %, about 75 wt % to about 96 wt %, about 80 wt % to about 95 wt %, or about 85 wt % to about 95 wt %, based on the total weight of the negative electrode coating layer.

In an implementation, the negative electrode coating layer may further include a binder. The binder may be a non-aqueous-based binder.

The non-aqueous binder may include, e.g., polyvinylchloride, carboxylated polyvinylchloride, polyvinyl fluoride, polyethylene oxide, an ethylene propylene copolymer, polystyrene, polyvinyl pyrrolidone, polyurethane, polytetrafluoroethylene, polyvinylidene fluoride, polyethylene, polypropylene, polyamideimide, polyimide, polyacrylate, or a combination thereof.

In an implementation, an amount of the binder may be, e.g., about 1 wt % to about 15 wt %, based on the total weight of the negative electrode coating layer. In an implementation, an amount of the binder may be, e.g., about 1 wt % to about 14 wt %, about 1 wt % to about 10 wt %, about 1 wt % to about 7, or about 1 wt % to about 5 wt %, based on the total weight of the negative electrode coating layer.

In an implementation, the negative electrode coating layer may further include the binder, a mixing amount of the metal and the carbon material may be adjusted depending on the amount of the binder, and a mixing (e.g., weight) ratio of the metal and the carbon material may be, e.g., about 1:40 to about 1:1, about 1:20 to about 1:2, about 1:10 to about 1:2, or about 1:5 to about 1:2.

Maintaining the amount of the binder in the negative electrode coating layer of the all solid-state battery within the weight ranges may help ensure that the electrical resistance and the adherence may be improved, thereby enhancing the battery characteristics, e.g., cycle-life characteristics of the all solid-state battery.

In an implementation, the negative electrode coating layer may have a thickness of, e.g., about 1 μm to about 20 μm. In an implementation, the thickness of the negative electrode coating layer may be about 1 μm or more, 3 μm or more, about 5 μm or more, about 20 μm or less, about 18 μm or less, about 16 μm or less, about 14 μm or less, about 12 μm or less, about 10 μm or less.

The current collector may include, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape. A thickness of the negative current collector may be, e.g., about 1 μm to 20 μm, about 5 μm to about 15 μm, or about 7 μm to about 10 μm.

In an implementation, the current collector may include the metal as a substrate and may further include a thin film on the substrate. The thin film may include an element being capable of forming an alloy with lithium, e.g., gold, silver, zinc, tin, indium, silicon, aluminum, bismuth, or a combination thereof, or other suitable element that forms an alloy with lithium. In an implementation, the current collector may further include a thin film, a more flattened lithium-containing layer may be formed, and the lithium may be deposited during charging to form the lithium-containing layer, thereby further improving the cycle-life characteristics of the all solid-state battery.

A thickness of the thin film may be, e.g., about 1 nm to about 800 nm, about 10 nm to about 700 nm, about 50 nm to about 600 nm, or about 100 nm to about 500 nm. Maintaining the thickness of the thin film within the ranges may help ensure that the cycle-life characteristics may be further enhanced.

The negative electrode according to one or more embodiments may further include a lithium-containing layer between the current collector and the negative electrode coating layer at the initial charge after the battery preparation. In an implementation, the thickness of the lithium-containing layer may be, e.g., about 1 μm to about 1,000 μm, about 1 μm to about 500 μm, about 1 μm to about 200 μm, about 1 μm to about 150 μm, about 1 μm to about 100 μm, or about 1 μm to about 50 μm. Maintaining the thickness of the lithium-containing layer within the ranges may help ensure that the lithium-containing layer effectively performs the role of a lithium reservoir and the cycle-life characteristics may be further enhanced.

The lithium-containing layer may be formed by releasing lithium ions from a positive active material, passing through the solid electrolyte, and moving move to the negative electrode, and thus, it may be precipitated and deposited on the negative current collector, after fabricating the battery.

The charging may be a formation process which may be performed at about 0.05 C to about 1 C at about 25° C. to about 50° C. one to three times. In an implementation, the lithium may be precipitated and deposited to form the lithium-containing layer, lithium included in the lithium-containing layer may be ionized during discharging to move to the positive direction, and thus, this lithium may be used as a negative active material.

In an implementation, the lithium-containing layer may be between the current collector and the negative electrode coating layer, the negative electrode coating layer may serve as a protecting layer for the lithium-containing layer, and thus, the deposition growth of lithium dendrite may be suppressed. This may help inhibit capacity fading and short-circuit of the all solid-state battery and may resultantly improve the cycle-life of the all solid-state battery.

### <Solid Electrolyte Layer>

In an implementation, the solid electrolyte layer may include a solid electrolyte. The solid electrolyte may include, e.g., a sulfide solid electrolyte. The sulfide solid electrolyte may have excellent ionic conductivity and excellent cycle-life characteristics within the wider operation range, than other solid electrolytes, e.g., an oxide solid electrolyte.

A sulfide solid electrolyte could filtrate or infiltrate the negative electrode during charging and discharging the all solid-state battery, causing problems related to the reaction with the negative current collector. Stainless steel (which is expensive and not electrochemically reactive with the sulfide solid electrolyte, and may be difficult to thin, resulting in reduced energy density) could be used as a negative current collector. In an implementation, the all solid-state battery according to one or more embodiments, may use a negative electrode having a copper current collector and the sulfide solid electrolyte together, because the negative electrode may include the negative electrode with the negative electrode protection layer, as previously described. The all solid-state battery with both the advantageous due to the usage of the sulfide solid electrolyte and the advantageous due the usage of the copper current collector may be provided.

The sulfide solid electrolyte may include, e.g., Li₂S—P₂S₅, Li₂S—P₂S₅—LiX (in which X may be an halogen element, e.g., I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n may each be an integer of about 0 or more and about 12 or less, Z may be Ge, Zn, or Ga), Li₂S—GeS₂, Li₂S—SiS₂—Li₃PO₄, Li₂S—SiS₂-LiₚMO_{q} (in which p and q may each be an integer of about 0 or more and about 12 or less and M may be P, Si, Ge, B, Al, Ga, or In), LiₐM_{b}P_{c}SₐAₑ (in which a, b, c, d, and e may each be an integer of about 0 or more and about 12 or less, M may be Ge, Sn, Si, or a combination thereof, and A may be F, Cl, Br, or I). In an implementation, the sulfide solid electrolyte may include, e.g., Li₇₋ₓPS₆₋ₓFₓ (0≤x≤2), Li₇₋ₓPS₆₋ₓClₓ (0≤x≤2), Li₇₋ₓPS₆₋ₓBrₓ (0≤x≤2), or Li₇₋ₓPS₆₋ₓIₓ (0≤x≤2). In an implementation, the sulfide solid electrolyte may include, e.g., Li₃PS₄, Li₂P₃S₁₁, Li₂PS₆, Li₆PS₅Cl, Li₆PS₅Cl, Li₆PSI, Li₆PS₅Br, Li_{5.8}PS_{4.8}Cl_{1.2}, Li_{6.2}PS_{5.2}Br_{0.8}, or the like.

In an implementation, the sulfide solid electrolyte may be an argyrodite-type sulfide solid electrolyte. The argyrodite-type sulfide solid electrolyte may include, e.g., LiₐM_{b}P_{c}SₐAₑ (in which a, b, c, d, and e may each be an integer of about 0 or more and about 12 or less, M may be Ge, Sn, Si, or a combination thereof, and A may be F, Cl, Br, or I).

In an implementation, the sulfide solid electrolyte may include, e.g., Li₃PS₄, Li₂P₃S₁₁, Li—PS₆, Li₆PS₅Cl, Li₆PS₅Br, Li_{5.8}PS_{4.8}Cl_{1.2}, Li_{6.2}PS_{5.2}Br_{0.8}, Li₆PS₅I, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70} SO_{40.05}) Cl_{1.25}, (Li_{5.69}Cu_{0.06})P(S_{4.60} SO_{40.15}) Cl_{1.25}, (Li_{5.72}Cu_{0.03})P(S_{4.725} SO_{40.025}) Cl_{1.25}, (Li_{5.72}Na_{0.03})P(S_{4.725} SO_{40.025}) Cl_{1.25}, Li_{5.75}P(S_{4.725} SO_{40.025}) Cl_{1.25}, or combination thereof.

The sulfide solid electrolyte may be amorphous, crystalline, or a combination thereof. The sulfide solid electrolyte may be prepared, e.g., by mixing Li₂S and P₂S₅ at a mole ratio of about 50:50 to about 90:10, or about 50:50 to about 80:20. In the ranges of the mixing ratio, the sulfide solid electrolyte exhibiting excellent ionic conductivity may be prepared. As other components, SiS₂, GeS₂, B₂S₃, or the like may be further included thereto, thereby further improving ionic conductivity.

The mixing procedure of the sulfur-included source for preparing the sulfide solid electrolyte may be performed by a mechanical milling or a solution method. The mechanical milling may be performed by adding starting raw material, a ball mill, or the like in a reactor and vigorously stirring to pulverize the starting raw material and to mix them together. The solution method may provide a solid electrolyte as a precipitate by mixing starting raw material in a solvent. In an implementation, a heat treatment may be performed after mixing, and the crystal of the solid electrolyte may be further solidified and ionic conductivity may be further improved. In an implementation, the sulfide solid electrolyte may be prepared by mixing sulfur-included raw materials and heat-treating them two or more times, which may provide a sulfide solid electrolyte with high ionic conductivity and rigidity.

The sulfide solid electrolyte may be a commercial solid electrolyte.

The solid electrolyte may have a particle shape. An average particle diameter D50 of the solid electrolyte may be about 5.0 μm or less, e.g., about 0.1 μm to about 5.0 μm, about 0.5 μm to about 5.0 μm, about 0.5 μm to about 4.0 μm, about 0.5 μm to about 3.0 μm, about 0.5 μm to about 2.0 μm, or 0.5 μm to about 1.0 μm.

In an implementation, the solid electrolyte layer may further include a binder. The binder may include, e.g., a styrene butadiene rubber, polytetrafluoroethylene, polyvinylidene fluoride, polyethylene, an acrylate-based polymer, or a combination thereof, or other suitable material. The acrylate polymer may include, e.g., butyl acrylate, polyacrylate, polymethacrylate, or a combination thereof.

In an implementation in which the solid electrolyte layer further includes the binder, an amount of the solid electrolyte may be, based on the total weight of the solid electrolyte layer, e.g., about 95 wt % to about 99.5 wt %, about 96 wt % to about 99.5 wt %, or about 97 wt % to about 99 wt %, and an amount of the binder may be, based on the total weight of the solid electrolyte layer, e.g., about 0.5 wt % to about 5 wt %, about 0.5 wt % to about 4 wt %, or about 1 wt % to about 3 wt %.

The solid electrolyte layer may further include an alkali metal salt, an ionic liquid, or a conductive polymer.

The alkali metal salt may be, e.g., a lithium salt. In the solid electrolyte layer, an amount or concentration of the lithium salt may be about 1 M or more, e.g., about 1 M to about 4 M. In this case, the lithium salt may help improve the lithium ion mobility of the solid electrolyte layer, thereby improving ionic conductivity.

The lithium salt, may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃ C₂F₅, lithium bis(oxalato) borate (LiBOB), lithium oxalyldifluoroborate (LIODFB), lithium difluoro (oxalato) borate (LiDFOB), lithium bis(trifluoro methanesulfonyl)imide, (LiTFSI), LiN(SO₂CF₃)₂), lithium bis(fluorosulfonyl)imide (LiFSI, LiN(SO₂F)₂), LiCF₃SO₃, LiAsF₆, LiSbF₆, LiClO₄ or a mixture thereof.

The lithium salt may include an imide lithium salt, e.g., lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt may suitably maintain the chemical reactivity with the ionic liquid, and thus, the ionic conductivity may be maintained or improved.

The ionic liquid may have a melting point of a room temperature or less which may be a liquid state at a room temperature and salts consisting of only ion, or a room-temperature molten salt.

In an implementation, the ionic liquid may be a compound including a cation, e.g., ammonium, pyrrolidinium, pyridinium, pyrrimidinium, imidazolium, piperridinium, pyrazolium, oxazolium, pyridazinium, phosphonium, sulfonium, triazolium, or a mixture thereof, and an anion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, FSO₂₂N⁻, (C₂F₅SO₂)₂N⁻, (C₂F₅SO₂)(CF₃SO₂)N⁻, or (CF₃SO₂)₂N⁻.

The ionic liquid may include, e.g., N-methyl-N-propylpyrroledinium bis(trifluoromethanesulfonyl)imide, N-butyl-N-methylpyrroleridium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide.

In the solid electrolyte layer, a weight ratio of the solid electrolyte and the ionic liquid may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer including the solid electrode and the ionic liquid within the ranges may have an improved electrochemical contact area to the electrode, and thus, the ionic conductivity may be maintained or improved. This may help improve the energy density, discharge capacity, rate capability, or the like of the all solid-state battery.

### <Positive Electrode>

The positive electrode according to one or more embodiments may include a positive current collector and a positive active material layer on the positive current collector.

The positive active material layer may include a positive active material. The positive active material may include compounds that reversibly intercalate and deintercalate lithium ions. In an implementation, it may include a composite oxide of cobalt, manganese, nickel, or a combination thereof, and lithium. The positive active material may include, e.g., LiₐA_{1-b}B_{b}¹D₂¹ (0.90≤a≤1.8, 0≤b≤0.5); LiₐE_{1-b}B_{b}¹O_{2-c}D_{c}¹ (0.90≤a≤1.8, 0≤b≤0.5, 0≤c≤0.5); LiₐE_{2-b}B_{b}¹O_{4-c}D_{c}¹ (0.90≤a≤1.8, 0≤b≤0.5, 0≤c≤05); LiₐNi_{1-b-c}Co_{b}B_{c}¹D_{α}¹ (0.90≤a≤1.8, 0≤b≤0.5, 0≤c≤0.5, 0<α<2); LiₐNi_{1-b-c}Co_{b}B_{c}¹O_{2-α}F_{α}¹ (0.90≤a≤1.8, 0≤b≤0.5, 0≤c≤0.5, 0<α<2); LiₐNi_{1-b-c}Co_{b}B_{c}¹O_{2-α}F₂¹ (0.90≤a≤1.8, 0≤b≤0.5, 0≤c≤0.5, 0≤α≤2); LiₐNi_{1-b-c}Mn_{b}B_{c}¹D_{α}¹ (0.90≤a≤1.8, 0≤b≤0.5, 0≤α≤0.5, 0≤α≤2); LiₐNi_{1-b-c} Mn_{b}B_{c}¹O_{2-α}F_{α}¹ (0.90≤a≤1.8, 0≤b≤0.5, 0≤α≤0.5, 0≤α≤2); LiₐNi_{1-b-c}Mn_{b}B_{c}¹O_{2-α}F₂¹ (0.90≤a≤1.8, 0≤b≤0.5, 0≤c≤0.5, 0≤α≤2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L_{d}¹GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄; Li_{(3-f)}J₂ (PO₄)₃ (0≤f≤2); Li_{(3-F)}FE₂(PO₄)₃ (0≤f≤2); or LiFePO₄.

In the chemical formulas, A may be, e.g., Ni, Co, Mn, or a combination thereof; B¹ may be, e.g., Al, Ni, Co, Mn, Cr, Fe, Mg, Sr, V, a rare earth element, or a combination thereof; D¹ may be, e.g., O, F, S, P, or combination thereof; E may be, e.g., Co, Mn, or combination thereof; F¹ may be, e.g., F, S, P, or a combination thereof; G may be, e.g., Al, Cr, Mn, Fe, Mg, La, Ce, Sr, V, or a combination thereof; Q may be, e.g., Ti, Mo, Mn, or a combination thereof; I¹ may be, e.g., Cr, V, Fe, Sc, Y, or a combination thereof; J may be, e.g., V, Cr, Mn, Co, Ni, Cu, or a combination thereof; L¹ may be, e.g., Mn, Al, or a combination thereof.

In an implementation, the positive active material may include a (e.g., three-component) lithium transition metal oxide, e.g., LiNiₓCo_{y}Al_{z}O₂ (NCA), LiNiₓCo_{y}Mn_{z}O₂ (NCM) (wherein, 0<x<1, 0<y<1, 0<z<1, x+y+z=1), or the like.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or mixture thereof. The coating layer may be provided by a method having no (or substantially no) adverse influence on properties of a positive active material by using these elements in the compound. In an implementation, the method may include a suitable coating method, e.g., spray coating, dipping, or the like.

The coating layer may include suitable coating materials for the positive active material of the all solid battery. In an implementation, it may be a buffer layer which may help to reduce an interface resistance of the positive active material and the solid electrolyte. In an implementation, the buffer layer may include lithium-metal-oxide and this metal include, e.g., Al, B, Ca, Ce, Cr, Fe, Mg, Mo, Nb, Si, Sn, Sr, Ta, V, W, or Zr. The buffer layer may include, e.g., Li₂O—ZrO₂(LZO) or the like.

In an implementation, the positive active material may be a three-component material including nickel, cobalt, and manganese, or nickel, cobalt, and aluminum, the capacity density of the all solid-state battery may be further improved, and the metal elution from the positive active material at charged state may be further reduced. This may help further improve long reliability and cycle characteristics of the all solid-state battery at a charged state.

The average particle diameter of the positive active material may be about 1 μm to 25 μm, e.g., 3 μm to 25 μm, 1 μm to 20 μm, 1 μm to 18 μm, 3 μm to 15 μm, or 5 μm to 15 μm. In an implementation, the positive active material may include small particles with an average particle diameter D50 of about 1 μm to about 9 μm and large particles with an average particle diameter D50 of about 10 μm to about 25 μm. The positive active material with these particle diameter ranges may be harmoniously mixed with other components in the positive active material layer and may achieve high capacity and high energy density.

The positive active material may be secondary particle where a plurality of primary particles is agglomerated, or monocrystalline (single crystal). The shape of the positive active material may be, e.g., a spherical shape, a shape close to spherical, or a particle shape such as polyhedron, or unspecified shape, or the like.

In the positive active material layer, an amount of the positive active material may be in a suitable range which may be applied to a positive electrode layer of the conventional all solid-state secondary battery. In an implementation, based on the total weight of the positive active material layer, the positive active material may be included at about 55 wt % to about 99.5 wt %, e.g., about 65 wt % to about 95 wt %, or about 75 wt % to about 91 wt %.

In an implementation, the positive active material layer may further include a binder or a conductive material.

The binder may include, e.g., polyvinyl alcohol, carboxymethyl cellulose, hydroxypropyl cellulose, diacetylcellulose, polyvinylchloride, carboxylated polyvinylchloride, polyvinyl fluoride, polyethylene oxide, polyvinyl pyrrolidone, polyurethane, polytetrafluoroethylene, polyvinylidene fluoride, polyvinylidene fluoride-hexafluoropropylene, polyethylene, polypropylene, a styrene-butadiene rubber, an acrylated styrene-butadiene rubber, an epoxy resin, nylon, or the like.

The binder may be included in an amount of about 0.1 wt % to about 5 wt %, or about 0.1 wt % to about 3 wt %, based on the total weight of the positive active material layer. Within these ranges, the adhesion ability may be sufficiently secured without deteriorating the battery performance.

The conductive material may be included to provide electrode conductivity. A suitable electrically conductive material that does not cause a chemical change may be used. Examples of the conductive material may include a carbon material such as natural graphite, artificial graphite, carbon black, acetylene black, ketjen black, carbon fiber, carbon nanofiber, carbon nanotube, or the like; a metal material of a metal powder or a metal fiber including; copper, nickel, aluminum, silver, or the like; material; a conductive polymer such as polyphenylene derivatives; or mixtures thereof.

The conductive material may be included in an amount of about 0.1 wt % to about 5 wt %, or about 0.1 wt % to about 3 wt %, based on the total weight of the positive active material layer. Including conductive material in the above amount ranges may help improve the electrical conductivity without deteriorating battery performance.

The positive active material layer may further include solid electrolyte. The solid electrolyte included in the positive active material layer may be an inorganic solid electrolyte, e.g., a sulfide solid electrolyte, an oxide solid electrolyte, a halide solid electrolyte, or the like, or solid polymer electrolyte.

Based on the total weight of the positive active material layer, the solid electrolyte may be included at an amount of about 0.1 wt % about to 35 wt %, e.g., about 1 wt % to about 35 wt %, about 5 wt % to about 30 wt %, about 8 wt % to about 25 wt %, or about 10 wt % to about 20 wt %. In the positive active material layer, based on the total weight of the positive active material and the solid electrolyte, the positive active material of about 65 wt % to about 99 wt % and the solid electrolyte of about 1 wt % to about 35 wt % may be included, e.g., the positive active material of about 80 wt % to about 90 wt % and the solid electrolyte of about 10 wt % to about 20 wt % may be included. Including the solid electrolyte with the amount of the above ranges in the positive electrode may help ensure that the efficiency and cycle-life characteristic of the all solid-state battery may be improved, without deterioration of capacity.

The sulfide solid electrolyte may be as described above, and may be the same as or different from the solid electrolyte included in the solid electrolyte layer.

The oxide inorganic solid electrolyte may include, e.g. Li₁₊ₓTi₂₋ₓAl(PO₄)₃ (LTAP)(0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃ (PLZT) (0≤x<1, 0≤y<1), Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithiumtitaniumphosphate (LiₓTi_{y}PO₄₃, 0<x<2, 0<y<3), Li_{1+x+y}(Al, Ga)ₓ (Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ based ceramics, Garnet-based ceramics Li₃₊ₓLa₃M₂O₁₂ where M=Te, Nb, or Zr, x is an integer of about 1 to about 10), or a mixture thereof.

The solid polymer electrolyte may include, e.g., polyethylene oxide, poly(diallyldimethylammonium (TFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na,Li)₁₊ₓTi₂₋ₓAlₓ (PO₄)₃(0.1≤x≤0.9), Li₁₊ₓHf₂₋ₓAlₓ (PO₄)₃(0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (M where M is a rare earth elements such as Nd, Gd, Dy, or the like) Li₅ZrP₃O₁₂, Li₅TiP₃O₁₂, Li₃Fe₂P₃O₁₂, Li₄NbP₃O₁₂, Li₁₊ₓ(M,Al,Ga)ₓ (Ge_{1-y}Ti_{y})₂₋ₓ(PO₄)₃(0≤x≤0.8, 0≤y≤1.0, M is Nd, Sm, Eu, Gd, Tb, Dy, Ho, Er, Tm, or Yb), Li_{1+x+y}QₓTi₂₋ₓSi_{y}P_{3-y}O₁₂ (0<x 0.4, 0<y 0.6, Q is Al or Ga), Li₆BaLa₂Ta₂O₁₂, Li₂La₃Zr₂O₁₂, Li₅La₃Nb₂O₁₂, Li₅La₃M₂O₁₂ (M is Nb or Ta), or Li₂₊ₓAₓLa₃₋ₓZr₂O₁₂ (0<x<3, A is Zn).

The halide solid electrolyte may include a Li element, a M element (where M is a metal except for Li), and a X element (where X is a halogen). The X may be, e.g., F, Cl, Br, or I. In an implementation, the halide solid electrolyte may include Br or Cl, as the X. The M may be, e.g., Sc, Y, B, Al, Ga, In, or the like.

In an implementation, the halide solid electrolyte may be represented by, e.g., Li₆₋₃ₐMₐBr_{b}Cl_{c} (where, M is a metal, except for Li, 0<a<2, 05b≤6, 0≤c≤6, b+c=6). The a may be about 0.75 or more, or about 1 or more, and the a may be about 1.5 or less. The b may be about 1 or more, or about 2 or more. The c may be about 3 or more, or about 4 or more. The exemplary of the halide-based solid electrolyte may be Li₃YBr₆, Li₃YCl₆ or Li₃YBr₂Cl₄.

In an implementation, the positive current collector may include aluminum.

A thickness of the positive active material layer may be about 90 μm to about 200 μm. In an implementation, the thickness of the positive active material layer may be about 90 μm to about 190 μm, about 110 μm to about 180 μm, or about 130 μm to about 150 μm.

### <Elastic Layer>

The all solid-state battery according to one or more embodiments may further include an elastic layer which may help buffer changes in thickness generated during charging and discharging. The elastic layer may be between the negative electrode and a case.

The elastic layer may include materials having elasticity recovery rate of about 50% or more and insulating properties, e.g., may include a silicon rubber, an acryl rubber, a fluorine rubber, nylon, a synthetic rubber, or a combination thereof. The elastic layer may be a polymer sheet.

### <Method of Preparing a Negative Electrode>

In the all solid-state battery according to one or more embodiments, the negative electrode may be prepared by the following procedures.

A negative electrode protection layer composition may be coated on one side of the negative current collector to prepare a negative electrode protection layer. The negative electrode protection layer composition may be prepared by adding a fluorine adhesive, an acryl adhesive, a cyanoacrylate adhesive, a rubber adhesive, a polyurethane adhesive, a silicon adhesive, or a combination thereof, to a solvent. The solvent may include, e.g., N-methyl pyrrolidone, ethanol, hexane, water, or a combination thereof. In the negative electrode protection layer composition, a solid amount may be, based on the total weight of the negative electrode protection layer, e.g., about 1 wt % to about 90 wt %, about 5 wt % to about 70 wt %, about 5 wt % to about 30 wt %, or about 7 wt % to about 15 wt %. Within these ranges, the negative electrode protection layer, which may help sufficiently suppress the reaction between the negative current collector and the solid electrolyte, may be suitably formed.

Thereafter, a negative electrode coating layer composition may be coated on one side of the negative current collector, which is opposite to the negative electrode protection layer, e.g., one side of the negative current collector in which the negative electrode protection layer is not formed, and dried to prepare a negative electrode coating layer.

### <Fabrication of all Solid-State Battery>

The all solid-state battery according to one or more embodiments may be fabricated by positioning a negative electrode, a positive electrode, and a solid electrolyte between the negative electrode and the positive electrode to prepare an assembly and pressurizing the assembly. The pressurization may be carried out at a temperature of about 25° C. to about 90° C. The pressurization may be carried out under a pressure of about 550 MPa, e.g., about 500 MPa or less, or about 1 MPa to about 500 MPa. The pressurization time may vary depending on temperature and pressure, e.g., it may be less than about 30 minutes. The pressurization may use, e.g., isostatic press, roll press, plate press, or warm isostatic press (WIP).

The all solid-state battery may be an unit battery including a structure of the positive electrode/the solid electrolyte layer/the negative electrode, a bicell including a structure of the positive electrode/the solid electrolyte layer/the negative electrode/the solid electrolyte layer/the positive electrode, or a stacked battery where the unit batteries are repeated.

The shapes of the all solid-state battery may include, e.g., a coin-type, a button-type, a sheet-type, a laminate-type, a cylindrical-type, or a flat-type, or the like. The all solid-state battery may be applied to medium-to-large batteries used in electric vehicles. In an implementation, the all solid-state battery may be also used in hybrid vehicles such a plug-in hybrid electric vehicle (PHEV), or the like. It may be applied to areas where a large amount of power storage is required, for example, it may also be applied to electric bicycles or power tools. Furthermore, the all solid-state rechargeable battery may be used in various fields such as portable electronic devices.

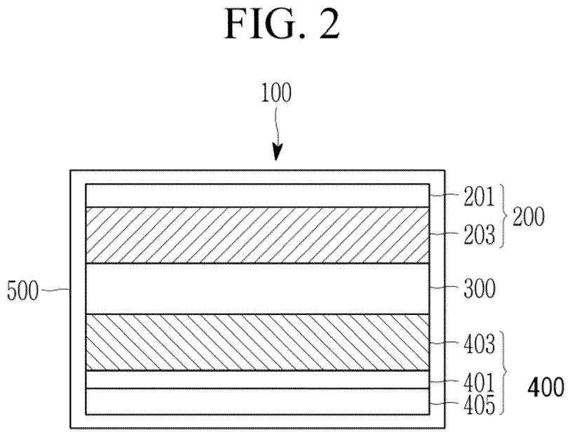

FIG. 2 is a cross-sectional view showing the all solid-state battery according to embodiments. Referring to FIG. 2, the all solid-state battery 100 may have a structure in which an electrode assembly is stacked with a negative electrode 400 including a negative electrode protection layer 405, a negative electrode current collector 401, and a negative electrode coating layer 403, a solid electrolyte layer 300, and a positive electrode 200 including a positive active material layer 203 and a positive current collector 201, are housed in a case 500 such as a pouch, or the like. The all solid-state batter may further include an elastic layer on the outside of at least one of the positive electrode 200 and the negative electrode 400.

A lithium deposition layer may be formed by releasing lithium ions from the positive electrode to deposit on the negative electrode current collector 401 during charging.

In an implementation, as illustrated in FIG. 2, one electrode assembly may include a negative electrode 400, a solid electrolyte layer 300, and a positive electrode 200, or an all solid-state battery may be fabricated by stacking at least two electrode assemblies. In an implementation, two to 100 electrode assemblies, three to 50 electrode assemblies, or 4 to 20 assemblies, or the like may be stacked.

### <All Solid-State Battery Stack>

An all solid-state stack according to one or more embodiments may include a first unit cell including a first negative electrode, a first positive electrode, a first solid electrolyte layer between the first negative electrode and the first positive electrode and a second unit cell including a second negative electrode, a second positive electrode, and a second solid electrolyte layer between the second negative electrode and the second positive electrode.

The elastic layer may be included between the first negative electrode protection layer and the second negative electrode protection layer. In an implementation, the elastic layer may be disposed between the first unit and the second unit.

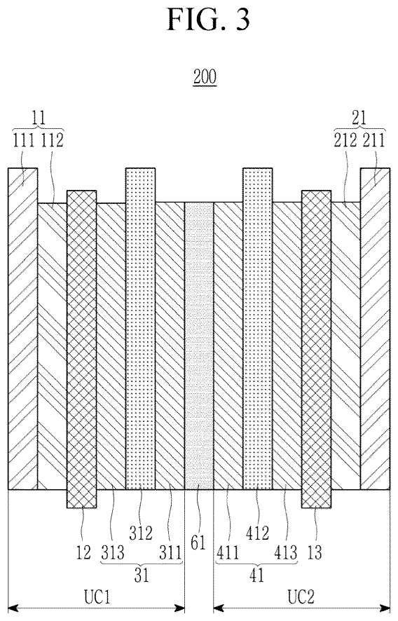

FIG. 3 schematically shows the all solid-state battery stack, and the all solid-state battery stack 200 according to one or more embodiments may include the first unit cell UC1 and the second unit cell UC2. Each unit cell may include the first and the second negative electrodes 31 and 41 including the negative electrode protection layers 311 and 411, the first and the second negative electrode current collectors 312 and 412, and the first and the second negative electrode coating layers 313 and 413, and the first and the second solid electrolyte layers 12 and 13, and the first and the second positive electrode 11 and 21 including the positive current collector 111 and 211, and the first and the second positive active material layers 112 and 212. An elastic layer 61 may be included between the first negative electrode protection layer 311 and the second negative electrode protection layer 411.

The elastic layer may be the same as previously described. The first negative electrode and the second negative electrode may be the negative electrode as previously described, and the first positive electrode and the second positive electrode may be the positive electrode as previously described. The first solid electrolyte layer and the second solid electrolyte layer may be the solid electrolyte layer as previously described.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### (1)Preparation of Negative Electrode

A polyvinylidene fluoride binder was added to an N-methyl pyrrolidone solvent to prepare a negative electrode protection layer composition including 5 wt % of the polyvinylidene fluoride binder.

Carbon black and silver (having an average particle diameter D50 of 60 nm) were mixed at a weight ratio of 75:25 to prepare a mixture, and then 0.25 g of the mixture was added to 2 g of an N-methyl pyrrolidone solution including 7 wt % of a polyvinylidene fluoride binder to prepare a negative electrode coating layer composition.

The negative electrode protection layer composition was coated on one side of a copper foil current collector (having a thickness of 10 μm) and dried to prepare a negative electrode protection layer.

The negative coating layer composition was coated on other side of the copper foil current collector (opposite the negative electrode protection layer, e.g., the side opposite to the negative electrode protection layer of the copper foil current collector), and vacuum-dried at 80° C. to prepare a negative electrode.

In the prepared negative electrode, the thickness of the negative electrode protection layer was 0.1 μm and the thickness of the negative electrode coating layer was 10 μm.

### (2)Preparation of Solid Electrolyte Layer

To an argyrodite-type solid electrolyte Li₆PS₅Cl, a binder solution in which butyl acrylate as an acrylate polymer was added to an isobutylyl isobutylate binder solution (solid amount: 50 wt %) and then mixed. A mixing ratio of the solid electrolyte and the binder was set to be a weight ratio of 98.7:1.3.

The mixing process was carried out using a Thinky mixer. The mixture was added with a 2 mm zirconia ball and was repeatedly agitated using a Thinky mixer to prepare a slurry. The slurry was casted on a release polytetrafluoroethylene film and dried at ambient temperature to prepare a solid electrolyte layer with a thickness of 100 μm.

### (3)Preparation of Positive Electrode

A positive active material (LiNi_{0.9}Mn_{0.05}Co_{0.05}O₂), an argyrodite-type solid electrolyte Li₆PS₅Cl, a carbon nano fiber conductive material, and a polytetrafluoroethylene binder were mixed at a weight ratio of 85:15:3:1.5 to prepare a mixture.

The mixture was coated on an aluminum foil current collector and then vacuum-dried at 45° C. to prepare a positive electrode including a positive active material layer with a thickness of 160 μm and the current collector with a thickness of 10 μm.

### (4) Fabrication of all Solid-State Cell

The prepared negative electrode, the solid electrolyte layer, and the positive electrode were sequentially stacked and pressurized under a press at 500 MPa to fabricate an all solid-state cell.

### Example 2

A negative electrode and an all solid-state cell were fabricated by the same procedure as in Example 1, except that a negative electrode protection layer having a thickness of 1 μm was prepared.

### Example 3

A negative electrode and an all solid-state cell were fabricated by the same procedure as in Example 1, except that a negative electrode protection layer having a thickness of 3 μm was prepared.

### Example 4

A negative electrode and an all solid-state cell were fabricated by the same procedure as in Example 1, except that a negative electrode protection layer having a thickness of 10 μm was prepared.

### Example 5

A negative electrode and an all solid-state cell were fabricated by the same procedure as in Example 1, except that a negative electrode protection layer having a thickness of 0.1 μm was prepared by using a negative electrode protection layer composition including 1 wt % of the polyvinylidene fluoride binder.

### Example 6

A negative electrode and an all solid-state cell were fabricated by the same procedure as in Example 5, except that a negative electrode protection layer having a thickness of 10 μm was prepared.

### Comparative Example 1

### (1)Preparation of Negative Electrode

92 wt % of carbon black having an average particle diameter D50 of 30 nm, 3 wt % Ag having an average size of 60 nm, 2 wt % of carboxymethyl cellulose, and 3 wt % of a styrene-butadiene rubber were mixed in water to prepare negative electrode coating layer slurry.

The negative electrode coating layer slurry was coated on a copper foil current collector having a thickness of 10 μm and vacuum-dried at 80° C. to prepare a negative electrode. In the negative electrode, the thickness of the negative electrode coating layer was 10 μm.

### (2) Fabrication of all Solid-State Full Cell

The negative electrode, the positive electrode of Example 1, and the solid electrolyte layer of Example 1 were used to fabricate an all solid-state cell.

### Comparative Example 2

A negative electrode and an all solid-state cell were fabricated by the same procedure as in Comparative Example 1, except that a stainless steel current collector having a thickness of 10 μm was used.

### Comparative Example 3

### (1)Preparation of Negative Electrode

92 wt % of carbon black having an average particle diameter D50 of 30 nm, 3 wt % Ag having an average size of 60 nm, 2 wt % of carboxymethyl cellulose, and 3 wt % of a styrene-butadiene rubber were mixed in water to prepare negative electrode coating layer slurry.

10 wt % of a polyvinylidene fluoride binder and 90 wt % of a carbon black conductive material were mixed in an N-methyl pyrrolidone solvent to prepare a conductive layer composition.

The conductive layer composition was coated on a copper foil current collector having a thickness of 10 μm and dried to prepare a conductive layer. Thereafter, the negative electrode coating layer slurry was coated on the conductive layer and vacuum-dried at 80° C. to prepare a negative electrode. In the negative electrode, the thickness of the conductive layer was 10 μm and the thickness of the negative electrode coating layer was 10 μm.

### (2) Fabrication of all Solid-State Full Cell

The negative electrode, the positive electrode of Example 1, and the solid electrolyte layer of Example 1 were used to fabricate an all solid-state cell.

### Comparative Example 4

### (1)Preparation of Negative Electrode

The negative electrode protection layer composition of Example 1 was coated on one side of a copper foil current collector having a thickness of 10 μm and dried to prepare a negative electrode protection layer.

The negative electrode coating layer composition of Example 1 was coated on the negative electrode protection layer and vacuum-dried at 80° C. to prepare a negative electrode.

In the negative electrode, the thickness of the negative electrode protection layer was 10 μm and the thickness of the negative electrode coating layer was 10 μm.

### (2) Fabrication of all Solid-State Full Cell

The negative electrode, the positive electrode of Example 1, and the solid electrolyte layer of Example 1 were used to fabricate an all solid-state cell by the same procedure as in Example 1.

### Experimental Example 1) Image of Current Collector after Charging and Discharging

The all solid-state cells of Examples 1 to 6 and Comparative Examples 1 to 4 were charged and discharged at 0.33 C for 100 cycles at 25° C. Charging and discharging did not occur in the all solid-state cell of Comparative Example 4, so that subsequent experiments could not be performed.

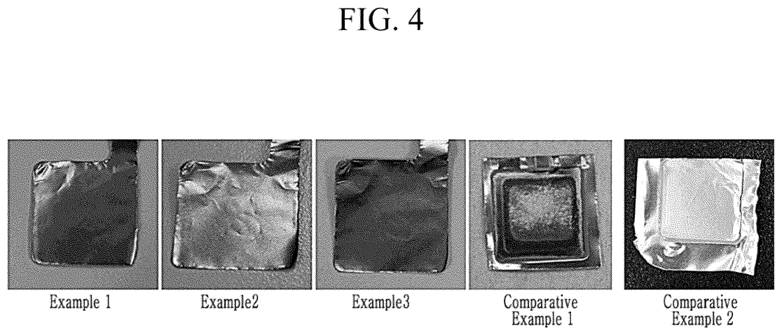

After charging and discharging, the cell was disassembled to separate the negative electrode current collector. The images for Examples 1 to 3 and Comparative Examples 1 and 2 of the separated current collectors are shown in FIG. 4.

As shown in FIG. 4, in case of Examples 1 to 3, the negative electrode protection layer was located between the current collector and the negative electrode coating layer so that the corrosion of the current collector was inhibited during charge and discharge. It may be seen that such corrosion inhibition is similar to the results of the cell in Comparative Example 2 using a stainless steel current collector.

In Comparative Example 1, in which a negative electrode protection layer was not formed, it was observed that the corrosion of the current collector occurred excessively during charge and discharge.

### Experimental Example 2) Evaluation of Capacity

The all solid-state full cells according to Examples 1 to 6, and Comparative Examples 1 to 3 were charged at 0.1 C and discharged at 0.1C at 25° C. once, and then charged at 0.33 C and discharged at 0.33 C three times. Thereafter, the discharge capacity was measured. The results are shown in Table 1, as an initial capacity.

### Experimental Example 3) Measurement of Cycle-Life Characteristic

The all solid-state cells of Examples 1 to 6 and Comparative Examples 1 to 3 were charged and discharged at 0.33 C for 100 cycles at 45° C., and the discharge capacity was measured. A ratio of discharge capacity at 100^{th} cycle relative to 1^{st} cycle was calculated. The results are shown in Table 1, as capacity retention.

### Experimental Example 4) Evaluation of EOL (end of life)

The all solid-state cells of Examples 1 to 6 and Comparative Examples 1 to 3 were charged and discharged at 0.33 C for 110 cycles at 25° C., the number of cycles at which the capacity drop by 25% was measured according to the USABC (United States Advanced Battery Consortium) standard, was measured. The results are shown in Table 1, as EOL.

TABLE 1

| | Initial capacity | Capacity | |
|---|---|---|---|
| | (mAh/g) | retention (%) | EOL |
| Example 1 | 176.6 | 82.5 | 432 |
| Example 2 | 179.4 | 83.5 | 463 |
| Example 3 | 179.2 | 84.0 | 470 |
| Example 4 | 176.0 | 83.8 | 468 |
| Example 5 | 177.8 | 83.9 | 438 |
| Example 6 | 175.6 | 83.2 | 465 |
| Comparative Example 1 | 177.1 | 32.3 | 62 |
| Comparative Example 2 | 176.5 | 82.9 | 472 |
| Comparative Example 3 | 158.2 | 67.2 | 83 |

As shown in Table 1, the all solid-state cells of Examples 1 to 6 exhibited high ionic conductivity and initial capacity, and excellent cycle-life characteristics. In the all solid-state cells of Examples 1 to 6, the capacity did not decrease by 25% even after charging and discharging at 110 cycles.

The all solid-state cell of Comparative Example 1 exhibited excellent initial capacity, but showed a abruptly deteriorated cycle-life characteristics and deteriorated EOL characteristics.

The all solid-state cell of Comparative Example 2 exhibited low initial capacity, and slightly deteriorated cycle-life characteristics, and EOL characteristics.

The all solid-state cell of Comparative Example 3 exhibited low initial capacity, cycle-life characteristics, and EOL characteristics.

### Experimental Example 5) Evaluation of Cyclic Voltammetry: CV) Characteristic

The cyclic voltammetry voltage (scan speed: 1 mV/s) was measured by using a three-electrode system including the negative electrodes of Examples 1 to 6 and Comparative Examples 1 to 3, a lithium working electrode, and a lithium counter electrode with a potentiostat (Solartron Analytical, 1470E Multi-Channel Potentiostat) at 45° C.

The test was conducted by charging and discharging under the following conditions to check whether side reactions occurred. If the charge and the discharge is performed under the following conditions, the normal reaction is that no charging and discharging reaction occurs, and if a charge and discharge occurs, a side reaction occurs.
Voltage Sweep) OCV (open circuit voltage) charge
1st: 4.25 V charge and 0.1 V discharge
2nd: 4.25 V charge and 0.1 V discharge
3rd: 4.25 V charge and 0.1 V discharge
4th: 4.25 V charge and 0.1 V discharge
4.25 V charge

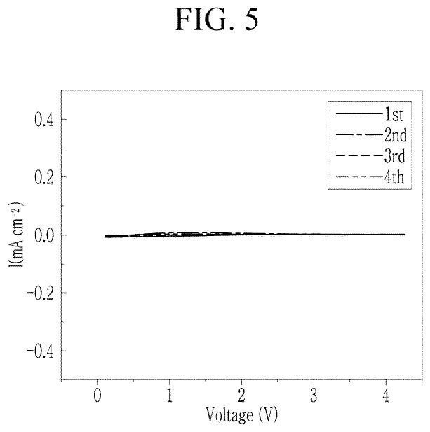

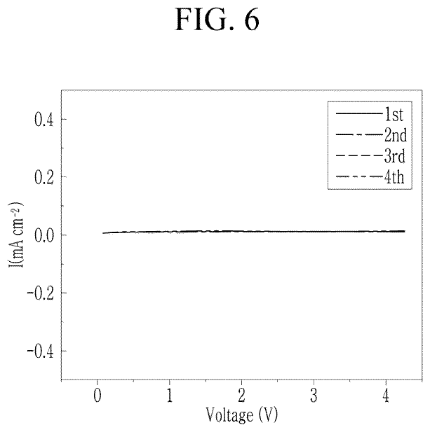

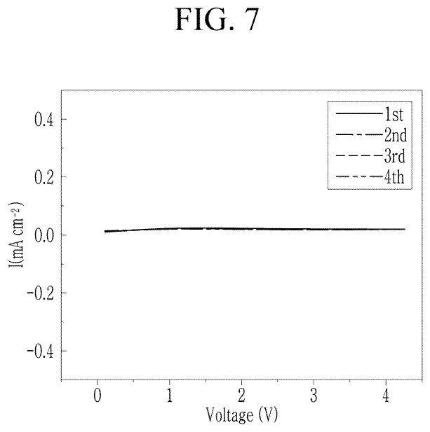

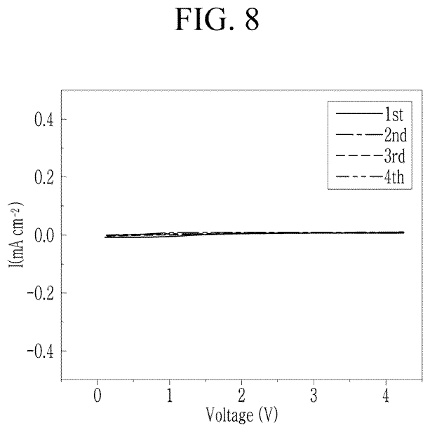

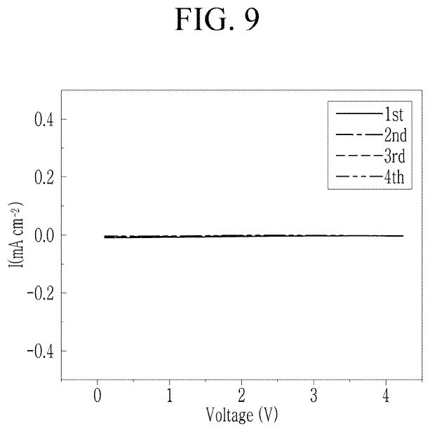

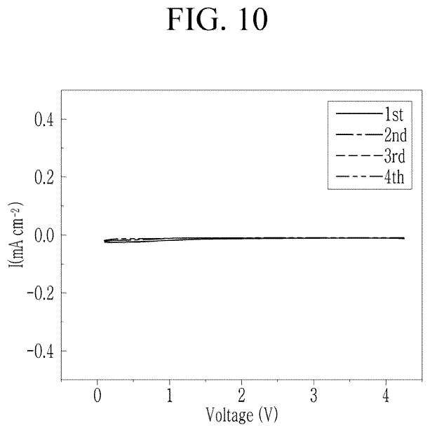

The result of Example 1 is shown in FIG. 5, the result of Example 2 is shown in FIG. 6, the result of Example 3 is shown in FIG. 7, the result of Example 4 is shown in FIG. 8, the result of Example 5 is shown in FIG. 9, and the result of Example 6 is shown in FIG. 10.

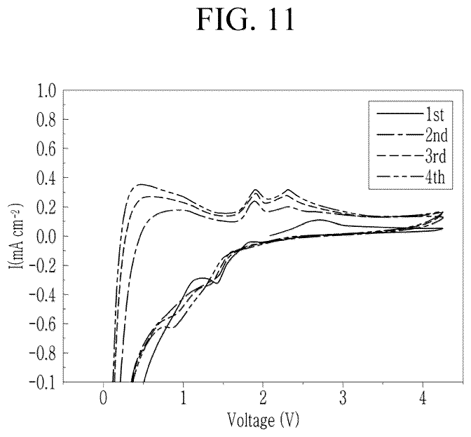

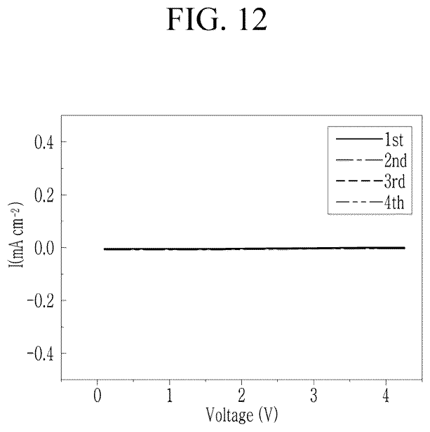

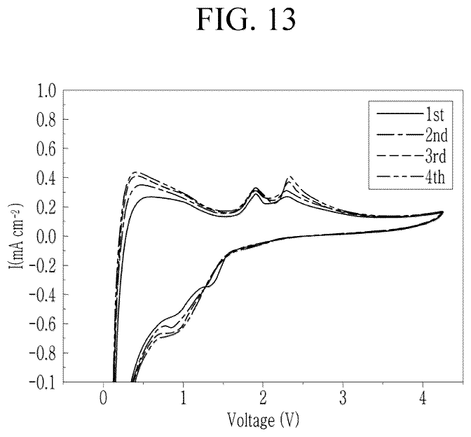

The result of Comparative Example 1 is shown in FIG. 11, the result of Comparative Example 2 is shown in FIG. 12, and the result of Comparative Example 3 is shown in FIG. 13.

As shown in FIG. 5 to FIG. 10, and FIG. 12, the negative electrodes of Examples 1 to 6 and the negative electrode of Comparative Example 2 exhibited a plateau graph which indicate no charge and discharge reaction.

As shown in FIG. 11 and FIG. 13, Comparative Examples 1 and 3 exhibited a charge and discharge peak which indicate the occurrence of the side reaction.

By way of summation and review, an all solid-state battery may be structurally strong because an electrolyte is solid, and thus, there may be a low risk of fire or explosion caused the electrolyte leakage due to external impact, or the like. The all solid-state battery may be formed in various shapes.

One or more embodiments may provide an all solid-state battery and an all solid-state battery stack which may help effectively suppress the reaction between the electrolyte and the current collector and exhibit excellent battery characteristics.

The all solid-state battery and the all solid-state battery according to one or more embodiments may effectively inhibit the reaction between the current collector and the electrolyte, thereby exhibiting excellent battery characteristics.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all solid-state battery, comprising:
a negative electrode including:
a negative electrode protection layer,
a negative electrode coating layer, and
a negative electrode current collector between the negative electrode protection layer and the negative electrode coating layer;
a positive electrode; and
a solid electrolyte layer between the negative electrode and the positive electrode.

2. The all solid-state battery as claimed in claim 1, wherein the negative electrode protection layer is an insulation layer.

3. The all solid-state battery as claimed in claim 1, wherein the negative electrode protection layer includes a fluorine adhesive, an acryl adhesive, a cyanoacrylate adhesive, a rubber adhesive, a polyurethane adhesive, a silicon adhesive, or a combination thereof.

4. The all solid-state battery as claimed in claim 3, wherein:
the fluorine adhesive includes polyvinylidene fluoride, polyvinylidene fluoride-hexafluoropropylene, polytetrafluoroethylene, or a combination thereof;
the acryl adhesive includes polyacrylic acid, polymethyl acrylate, polybutyl acrylate, polymethyl methacrylate, poly(ethylene-co-methyl acrylate), or a combination thereof;
the cyanoacrylate adhesive includes polymethyl cyanoacrylate, polyethyl cyanoacrylate, polybutyl cyanoacrylate, polyoctyl cyanoacrylate, or a combination thereof;
the rubber adhesive includes polyisoprene, a styrene-butadiene rubber, neoprene, or a combination thereof;
the polyurethane adhesive includes 4,4′-, 2,4′- or 2,2′-dicyclohexylmethanediisocyanate, or a mixture thereof; 1,3- or 1,4-bis(isocyanatomethyl)cyclohexane, or a mixture thereof; 3-isocyanatomethyl-3,5,5-trimethylcyclohexylisocyanate, 2,5- or 2,6-bis(isocyanatomethyl) norbornane or a mixture thereof, or a combination thereof; and
the silicon adhesive includes polymethyl siloxane, poly methyl phenyl siloxane, trimethylsilyl-terminated-polymethylsiloxane, or a combination thereof.

5. The all solid-state battery as claimed in claim 1, wherein the negative electrode protection layer has a thickness of about 0.1 μm to about 30 μm.

6. The all solid-state battery as claimed in claim 1, wherein the negative electrode current collector includes copper.

7. The all solid-state battery as claimed in claim 1, wherein the solid electrolyte layer includes a sulfide solid electrolyte.

8. The all solid-state battery as claimed in claim 1, wherein the negative electrode coating layer includes a metal and a carbon material.

9. The all solid-state battery as claimed in claim 8, wherein the metal includes Ag, Au, Sn, Zn, Al, Mg, Ge, Cu, In, Ni, Bi, Pt, Pd, or a combination thereof.

10. The all solid-state battery as claimed in claim 8, wherein the carbon material includes crystalline carbon, amorphous carbon, or a combination thereof.

11. An all solid-state battery stack, comprising:
a first unit battery including a first negative electrode, a first positive electrode, and a first solid electrolyte layer;
a second unit battery including a second negative electrode, a second positive electrode, and a second solid electrolyte layer; and
an elastic layer between the first unit battery and the second unit battery,
wherein:
the first negative electrode includes a first negative electrode coating layer, a first negative electrode current collector, and a first negative electrode protecting layer,
the second negative electrode includes a second negative electrode coating layer, a second negative electrode current collector, and a second negative electrode protecting layer, and
the elastic layer is between the first negative electrode protecting layer and the second negative electrode protecting layer.

12. The all solid-state battery stack as claimed in claim 11, wherein the first negative electrode protection layer and the second negative electrode protection layer are each an insulation layer.

13. The all solid-state battery stack as claimed in claim 11, wherein the first negative electrode protection layer and the second negative electrode protection layer each independently include a fluorine adhesive, an acryl adhesive, a cyanoacrylate adhesive, a rubber adhesive, a polyurethane adhesive, a silicon adhesive, or a combination thereof.

14. The all solid-state battery stack as claimed in claim 13, wherein:
the fluorine adhesive includes polyvinylidene fluoride, polyvinylidene fluoride-hexafluoropropylene, polytetrafluoroethylene, or a combination thereof;
the acryl adhesive includes polyacrylic acid, polymethyl acrylate, polybutyl acrylate, polymethyl methacrylate, poly(ethylene-co-methyl acrylate), or a combination thereof;
the cyanoacrylate adhesive includes polymethyl cyanoacrylate, polyethyl cyanoacrylate, polybutyl cyanoacrylate, polyoctyl cyanoacrylate, or a combination thereof;
the rubber adhesive includes polyisoprene, a styrene-butadiene rubber, neoprene, or a combination thereof;
the polyurethane adhesive includes 4,4′-, 2,4′- or 2,2′-dicyclohexylmethanediisocyanate, or a mixture thereof; 1,3- or 1,4-bis(isocyanatomethyl)cyclohexane, or a mixture thereof; 3-isocyanatomethyl-3,5,5-trimethylcyclohexylisocyanate, 2,5- or 2,6-bis(isocyanatomethyl) norbornane or a mixture thereof, or a combination thereof; and
the silicon adhesive includes polymethyl siloxane, poly methyl phenyl siloxane, trimethylsilyl-terminated-polymethylsiloxane, or a combination thereof.

15. The all solid-state battery stack as claimed in claim 11, wherein the first negative electrode protection layer and the second negative electrode protection layer each independently have a thickness of about 0.1 μm to about 30 μm.

16. The all solid-state battery stack as claimed in claim 11, wherein the first negative electrode current collector and the second negative electrode current collector each include copper.

17. The all solid-state battery stack as claimed in claim 11, wherein the first solid electrolyte layer and the second solid electrolyte layer each independently include a sulfide solid electrolyte.

18. The all solid-state battery stack as claimed in claim 11, wherein the first negative electrode coating layer and the second negative electrode coating layer each independently include a metal and a carbon material.

19. The all solid-state battery stack as claimed in claim 18, wherein the metal includes Ag, Au, Sn, Zn, Al, Mg, Ge, Cu, In, Ni, Bi, Pt, Pd, or a combination thereof.

20. The all solid-state battery stack as claimed in claim 18, wherein the carbon material includes crystalline carbon, amorphous carbon, or a combination thereof.
